(19) United States
(12) Patent Application Publication
(10) Pub. No.: US 2009/0255656 A1
(43) Pub. Date: Oct. 15, 2009

(54) Brazed Pipe and Method of Manufacturing the Same

(75) Inventors: Makoto Numasawa, Oyama-shi (JP); Mitsuru Nobusue, Oyama-shi (JP); Hirokazu Sanada, Oyama-shi (JP)

Correspondence Address: EDWARDS ANGELL PALMER & DODGE LLP, P.O. BOX 55874, BOSTON, MA, 02205, US

(73) Assignee: SHOWDA DENKO K.K., Tokyo (JP)

(21) Appl. No.: 12/225,434

(22) PCT Filed: Mar. 30, 2007
(86) PCT No.: PCT/JP2007/057194

§ 371 Date: Sep. 22, 2008

(30) Foreign Application Priority Data
Mar. 31, 2006 (JP) 2006-097314

(51) Int. Cl. F28F 9/02; F16L 9/14; B21D 53/02; B21D 53/06; B21D 39/03

(52) U.S. Cl. 165/173; 138/142; 29/890.052; 29/890.046; 228/153

(57) ABSTRACT

A method of manufacturing a brazed pipe comprises steps A to D. In the step A, on an upper surface of the right-hand side edge portion of a material plate 20 having a brazing material layer over opposite surfaces thereof, a first slant surface 21 is formed such that it inclines from the upper side toward the lower side while approaching the right end, and a first flat surface 22 is formed between the first slant surface 21 and the lower surface. In the step B, on a lower surface of the left-hand side edge portion of the material plate 20, a second slant surface 24 is formed such that it inclines from the lower side toward the upper side while approaching the left end, and a second flat surface 25 is formed between the second slant surface 24 and the lower surface. In the step C, the material plate 20 is formed into a tubular shape such that the slant surfaces 21 and 24 are in surface contact with each other, and the flat surfaces 22 and 25 abut against each other, whereby a brazed-pipe tubular body 34 is obtained. In the step D, the slant surfaces 21 and 24 and the flat surfaces 22 and 25 of the opposite side edge portions of the material plate 20 are respectively brazed together by making use of the brazing material layer of the material plate 20. According to the method of the present invention, a brazed pipe which has no step on the outer surface can be provided.

### TECHNICAL FIELD

The present invention relates to a brazed pipe and a method of manufacturing the same. More specifically, the present invention relates to a brazed pipe which is suitably used as a header in a heat exchanger, such as a condenser or an evaporator for car air conditioners, or an oil cooler for automobiles, and to a method of manufacturing such a brazed pipe.

In the present specification, the upper, lower, left, and right in FIG. 1 will be referred to as “upper,” “lower,” “left,” and “right,” respectively. Notably, in a description regarding FIG. 7, the upper, lower, left, and right in FIG. 7 will be referred to as “upper,” “lower,” “left,” and “right,” respectively. Further, in the present specification, the term “aluminum” encompasses not only pure aluminum but also aluminum alloys.

### BACKGROUND ART

FIG. 7 shows a heat exchanger (1) which is widely used as a condenser of a car air conditioner of a vehicle (see Patent Document 1). The heat exchanger (1) includes a pair of aluminum headers (2) and (3) which extend vertically and are disposed such that they are spaced apart from each other in the left-right direction; a plurality of aluminum heat exchange tubes (4) which are disposed between the headers (2) and (3) such that they are spaced apart from one another in the vertical direction, and opposite end portions of the tubes are connected to the corresponding headers (2) and (3); aluminum corrugate fins (5) each of which is disposed between and brazed to adjacent heat exchange tubes (4), or is disposed on the outer side of the uppermost or lowermost heat exchange tube (4) and brazed thereto; and side plates (6) which are disposed on the outer sides of the uppermost and lowermost corrugate fins (5) and brazed thereto. The left-hand header (2) is divided into upper and lower header sections (2a) and (2b) by means of a partition member (7) provided at a position higher than the center of the header with respect to the vertical direction. The right-hand header (3) is divided into upper and lower header sections (3a) and (3b) by means of another partition member (7) provided at a position lower than the center of the header with respect to the vertical direction. A fluid inlet (not shown) is formed on the upper header section (2a) of the left-hand header (2), and an inlet member (8) having a fluid inflow passageway (8a) is brazed to the upper header section (2a) such that the fluid inflow passageway (8a) communicates with the fluid inlet. A fluid outlet (not shown) is formed on the lower header section (3b) of the right-hand header (3), and an outlet member (9) having a fluid outflow passageway (9a) is brazed to the lower header section (3b) such that the fluid outflow passageway (9a) communicates with the fluid outlet.

Each of the left-hand and right-hand headers (2) and (3) of the above-described condenser (1) is composed of a brazed pipe (10) and aluminum closure members (11). The brazed pipe (10) is fabricated through a process in which an aluminum brazing sheet (material plate) having a brazing material layer over each of opposite surfaces thereof is formed into a tubular shape, and opposite side edge portions are partially overlapped with each other and brazed together. The closure members (11) are brazed to opposite ends of the brazed pipe (10) so as close the opposite end openings of the brazed pipe (10).

Although not illustrated in the drawings, the brazed pipe (10) is configured such that, of the opposite side edge portions of the material plate overlapped with each other, a first side edge portion located on the inner side has a first slant surface formed on the outer surface of the first side edge portion, the first slant surface extending over the entire thickness of the material plate and inclining inward toward the distal end; a second side edge portion located on the outer side has a second slant surface formed on the inner surface of the second side edge portion, the second slant surface extending over the entire thickness of the material plate and inclining outward toward the distal end; and the first and second slant surfaces are brazed together while being brought into surface contact with each other. The partition member (7) is inserted into the brazed pipe (10) through a partition-member-receiving slit and is brazed to the brazed pipe (10). The partition-member-receiving slit is formed in the brazed pipe (10) such that the slit extends across the opposite side edge portions of the material plate overlapped each other. The fluid inlet (the fluid outlet) is also formed in the brazed pipe (10) such that the fluid inlet (the fluid outlet) extends across the opposite side edge portions of the material plate overlapped with each other.

The above-described brazed pipe is manufactured by the following method.

That is, on one side edge portion of a material plate formed of an aluminum brazing sheet having a brazing material layer over each of opposite surfaces thereof, a first slant surface is formed over the entire thickness of the material plates such that the first slant surface inclines from the first face toward the second face of the material plate while approaching the distal end. Further, on the other side edge portion of the material plate, a second slant surface is formed over the entire thickness of the material plate such that the second slant surface inclines from the second face toward the first face of the material plate while approaching the distal end. Subsequently, the material plate is formed into a tubular shape such that the first face forms an outer surface, and the two slant surfaces are brought into surface contact with each other, whereby a tubular body which is to become the brazed pipe (hereinafter referred to as a “brazed-pipe tubular body”) is obtained. In this state, the slant surfaces are brazed together by making use of the brazing material layers of the material plate. Thus, the brazed pipe (10) is completed.

Incidentally, in such a method of manufacturing a brazed pipe, when a-brazed-pipe tubular body (18) is obtained by forming a material plate (15) into a tubular shape as shown in FIG. 8, two slant surfaces (16) and (17) may slide on each other and produce a misalignment in the thickness direction of the material plate (15). In such a case, a step may be formed on the outer surface of the brazed-pipe tubular body (18). Further, since a round surface (19) is formed between the first slant surface (16) and the outer surface of the brazed-pipe tubular body (18), the round surface (19) may form a step on the outer surface of the brazed-pipe tubular body (18).

If a step is formed on the outer surface of the brazed-pipe tubular body (18), the following problems may arise in some cases. In general, mutual brazing of the slant surfaces (16) and (17) of the brazed-pipe tubular body (18) is performed simultaneously with brazing of all the components of the condenser (1). Therefore, if a step is formed on the outer surface of the brazed-pipe tubular body (18), upon brazing of the inlet member (8) or the outlet member (9) to the brazed-pipe tubular body (18), a brazing failure may occur (see FIG. 9). In order to prevent occurrence of such a problem, troublesome work must be performed; specifically, it is necessary to prevent the slant surfaces (16) and (17) from sliding on each other during manufacture of the brazed-pipe tubular body (18), to thereby prevent formation of a step on the outer surface of the brazed-pipe tubular body (18). Therefore, there exists a problem in that the work for manufacturing the brazed pipe becomes complicated. Patent Document 1: Japanese Patent Publication (kokoku) No.

### DISCLOSURE OF THE INVENTION

### Problems to be Solved by the Invention

An object of the present invention is to solve the above problem and to provide a brazed pipe which does not have a step on an outer surface thereof, and a method by which such a brazed pipe can be easily manufactured.

### Means for Solving the Problems

To achieve the above object, the present invention comprises the following modes.

1) A brazed pipe fabricated through a process in which a material plate formed of a brazing sheet having a brazing material layer over each of opposite surfaces thereof is formed into a tubular shape, and opposite side edge portions of the material plate are partially overlapped with each other and brazed together by making use of the brazing material layer of the material palate, wherein

of the opposite side edge portions of the material plate overlapped with each other, a first side edge portion located on the inner side has a first slant surface which is formed on the outer surface thereof such that the first slant surface inclines inward toward a distal end of the first side edge portion; a second side edge portion located on the outer side has a second slant surface which is formed on the inner surface thereof such that the second slant surface inclines outward toward a distal end of the second side edge portion; a first flat surface is formed between the first slant surface and the inner surface of the first side edge portion such that the first flat surface forms an obtuse angle in relation to the first slant surface; a second flat surface is formed between the second slant surface and the inner surface of the second side edge portion such that the second flat surface forms an obtuse angle in relation to the second slant surface and the first flat surface abuts against the second flat surface; and the opposite side edge portions of the material plate are brazed together in a state where the first and second slant surfaces are in surface contact with each other and the first and second flat surfaces are in surface contact with each other.

2) A brazed pipe according to par. 1), wherein an obtuse edge portion is formed between the outer surface and the first slant surface of the first side edge portion; and an acute edge portion is formed between the outer surface and the second slant surface of the second side edge portion, so that the outer surfaces of the opposite side edge portions are smoothly connected.

3) A brazed pipe according to par. 1), wherein the width of the second flat surface of the second side edge portion as measured along the thickness direction of the material plate is equal to or greater than 20% the thickness of the material plate.

4) A brazed pipe according to par. 1), wherein an inner edge of the first flat surface of the first side edge portion projects inward in relation to an inner edge of the second flat surface of the second side edge portion.

5) A header for a heat exchanger which is formed by closing opposite end openings of the brazed pipe according to any one of pars. 1) to 4) by closure members, wherein a curved wall portion which bulges outward and has an arcuate transverse cross section is formed at a portion of the material plate excluding the overlapping opposite side edge portions thereof; and a plurality of heat-exchange-tube-receiving elongated holes extending in a circumferential direction of the curved wall portion are formed in the curved wall portion at predetermined intervals along a longitudinal direction thereof.

6) A heat exchanger comprising a pair of headers spaced apart from each other, a plurality of heat exchange tubes disposed between the headers and having opposite end portions connected to the corresponding headers, and fins disposed between adjacent heat exchange tubes, wherein

each of the headers is formed of the header for a heat exchanger according to par. 5); and the opposite end portions of the heat exchange tubes are inserted into the heat-exchange-tube-receiving elongated holes of the headers and are brazed to the corresponding brazed pipes.

7) A heat exchanger according to par. 6), wherein at least one header is divided by a partition member into a plurality of header sections arranged in a longitudinal direction of the header; and the partition member is inserted into the brazed pipe through a partition-member-receiving slit and brazed to the brazed pipe, the partition-member-receiving slit being formed across the opposite side edge portions of the material plate of the brazed pipe, which constitutes the header.

8) A heat exchanger according to par. 6), wherein the two headers are divided by respective partition members into equal numbers of header sections; a fluid inlet is formed in an one longitudinal end portion of a first header; a fluid outlet is formed in the opposite longitudinal end portion of a second header; and the fluid inlet and the fluid outlet are formed across the opposite side edge portions of the corresponding material plates of the respective brazed pipes, which constitute the first and second headers.

9) A heat exchanger according to par. 6), wherein a first header is divided by a partition member(s) into a plurality of header sections; a second header has header sections which number one less than the header sections of the first header and each of which faces adjacent two header sections of the first header; a fluid inlet is formed in a header section located at one longitudinal end of the first header; a fluid outlet is formed in a header section located at the other longitudinal end of the first header; and the fluid inlet and the fluid outlet are formed across the opposite side edge portions of the material plate of the brazed pipe which constitutes the first header.

10) A method of manufacturing a brazed pipe, comprising a step A of forming, on one side edge portion of a material plate formed of a brazing sheet having a brazing material layer over each of opposite surfaces thereof, a first slant surface such that the first slant surface is located on a first face of the material plate and inclines from the first face toward a second face of the material plate while approaching a distal end of the one side edge portion, and forming a first flat surface between the first slant surface and the second face such that the first flat surface forms an obtuse angle in relation to the first slant surface; a step B of forming, on the other side edge portion of the material plate, a second slant surface such that the second slant surface is located on the second face of the material plate and inclines from the second face toward the first face of the material plate while approaching a distal end of the other side edge portion, and forming a second flat surface between the second slant surface and the second face such that the second flat surface forms an obtuse angle in relation to the second slant surface; a step C of forming the material plate into a tubular shape such that the first face thereof is located on the outer side such that the first and second slant surfaces of the opposite side edge portions are in surface contact with each other and the first and second flat surfaces of the opposite side edge portions abut against each other, to thereby obtain a brazed-pipe tubular body; and a step D of brazing together the first and second slant surfaces and the first and second flat surfaces, respectively, of the opposite side edge portions of the material plate, which forms the brazed-pipe tubular body, by making use of the brazing material layer of the material plate, wherein, after one of the steps A and B is performed, the remaining one of the steps A and B is performed, and then the steps C and D are performed in this sequence.

11) A method of manufacturing a brazed pipe according to par. 10), wherein the first slant surface of the material plate formed in the step A and the second slant surface and the second flat surface of the material plate formed in the step B are each covered by the brazing material layer.

12) A method of manufacturing a brazed-pipe according to par. 10), wherein, in the step A, a portion of the material plate between the first face and the first slant surface is partially bulged toward the first face side to thereby form an obtuse edge portion between the first face and the first slant surface of the material plate.

13) A method of manufacturing a brazed pipe according to par. 10), wherein, in the step A, the first flat surface is formed such that the first flat surface perpendicularly intersects the second face of the material plate.

14) A method of manufacturing a brazed pipe according to par. 10), wherein, in the step B, an acute edge portion is formed between the first face and the second slant surface of the material plate.

15) A method of manufacturing a brazed pipe according to par. 10), wherein, in the step B, the second flat surface is formed such that the second flat surface perpendicularly intersects the second face of the material plate.

16) A method of manufacturing a brazed pipe according to par. 10), wherein, in the step B, the second flat surface is formed such that the width of the second flat surface becomes equal to or greater than 20% the thickness of the material plate.

17) A method of manufacturing a brazed pipe according to par. 10), wherein, in the step B, the second flat surface is formed such that the width of the second flat surface becomes smaller than that of the first flat surface formed in the step A.

18) A method of manufacturing a brazed pipe according to par. 10), wherein the brazed-pipe tubular body obtained in the step C has a step-free, smoothly connected inner surface at a location where the first and second flat surfaces are in contact with each other.

19) A method of manufacturing a header for a heat exchanger, wherein in the step C of the method of manufacturing a brazed pipe according to any one of pars. 10) to 18), before the material plate is formed into a tubular shape, a curved wall portion which bulges toward the first face side and has an arcuate transverse cross section is formed at an intermediate portion of the material plate with respect to a width direction thereof, and a plurality of heat-exchange-tube-receiving elongated holes extending in a circumferential direction of the curved wall portion are formed in the curved wall portion at predetermined intervals along a longitudinal direction of the material plate; and after completion of the step C, closure members are disposed at opposite end portions of the brazed-pipe tubular body formed from the material plate, and are brazed to the brazed-pipe tubular body, simultaneously with the mutual brazing of the first and second slant surfaces and the mutual brazing of the first and second flat surfaces in the step D.

20) A method of manufacturing a heat exchanger comprising a pair of headers spaced apart from each other, a plurality of heat exchange tubes disposed between the headers and having opposite end portions connected to the corresponding headers, and fins disposed between adjacent heat exchange tubes, wherein, after completion of the step C of the method according to par. 19), two brazed-pipe tubular bodies each formed of the material plate are disposed such that they are spaced apart from each other; the opposite end portions of the heat exchange tubes are inserted into the heat-exchange-tube-receiving elongated holes of the corresponding brazed-pipe tubular bodies; the fins are disposed between adjacent heat exchange tubes; and the heat exchange tubes are brazed to the brazed-pipe tubular bodies and the fins are brazed to the heat exchange tubes, simultaneously with the mutual brazing of the first and second slant surfaces, the mutual brazing of the first and second flat surfaces, and the brazing of the closure members to the brazed-pipe tubular bodies in the step D.

21) A method of manufacturing a heat exchanger according to par. 20), wherein, after completion of the steps A and B, cutouts are formed at corresponding positions of the opposite side edge portions of the material plate, from which at least one brazed-pipe tubular body is formed, whereby a partition-member-receiving slit is formed across the opposite side edge portions of the brazed-pipe tubular body obtained in the step C; a partition member is inserted into the brazed-pipe tubular body through the slit before performance of the step D; and the partition member is brazed to the brazed-pipe tubular body simultaneously with the brazing of the relevant components in the step D.

### EFFECTS OF THE INVENTION

In the brazed pipe of par. 1), of the opposite side edge portions of the material plate overlapped with each other, a first side edge portion located on the inner side has a first slant surface which is formed on the outer surface thereof such that the first slant surface inclines inward toward a distal end of the first side edge portion; a second side edge portion located on the outer side has a second slant surface which is formed on the inner surface thereof such that the second slant surface inclines outward toward a distal end of the second side edge portion; a first flat surface is formed between the first slant surface and the inner surface of the first side edge portion such that the first flat surface forms an obtuse angle in relation to the first slant surface; a second flat surface is formed between the second slant surface and the inner surface of the second side edge portion such that the second flat surface forms an obtuse angle in relation to the second slant surface and the first flat surface abuts against the second flat surface; and the opposite side edge portions of the material plate are brazed together in a state where the first and second slant surfaces are in surface contact with each other and the first and second flat surfaces are in surface contact with each other. Therefore, in a state in which the opposite side edge portions of the material plate are brazed together, the flat surfaces of the opposite side edge portions abut against each other, to thereby prevent misalignment between the two slant surfaces of the brazed-pipe tubular body formed by forming the material plate into a tubular shape, whereby formation of a step on the outer surface of the brazed-pipe tubular body is prevented. Accordingly, the manufactured brazed pipe does not have a step on the outer surface thereof. In addition, since the misalignment between the two slant surfaces can be prevented through formation of the material plate into a tubular shape such that the two flat surfaces abut against each other, no special work for preventing the misalignment is needed, and the manufacturing work becomes simple. Further, since formation of a step on the outer surface of the brazed-pipe tubular body is prevented, the following advantage is attained. For example, in the case where, simultaneously with manufacture of the brazed pipe, an additional component is brazed to the brazed-pipe tubular body such that the component extends across the opposite side edge portions of the material plate of the brazed-pipe tubular body, no clearance is formed between the additional component and the outer surface of the brazed-pipe tubular body. Accordingly, it becomes possible to prevent occurrence of a brazing failure between the manufactured brazed pipe and the additional component.

In the brazed pipe of par. 2), an obtuse edge portion is formed between the outer surface and the first-slant surface of the first side edge portion; and an acute edge portion is formed between the outer surface and the second slant surface of the second side edge portion, so that the outer surfaces of the opposite side edge portions are smoothly connected. This structure prevents formation of a step on the outer surface of the brazed-pipe tubular body before undergoing brazing, as well as formation of a step on the outer surface of the manufactured brazed pipe.

According to the brazed pipe of par. 3), it becomes possible to more reliably prevent the misalignment between the two slant surfaces of the brazed-pipe tubular body in a state in which the opposite side edge portions thereof have not yet been brazed together.

According to the header for a heat exchanger of par. 5), effects similar to those of the brazed pipes of pars. 1) to 3) can be attained.

According to the heat exchangers of pars. 8) and 9), no step is formed on the outer surface of the brazed-pipe tubular body, which constitutes the header, in a state in which the brazed-pipe tubular body has not yet undergone brazing, and thus, the following advantage is attained. For example, in the case where, simultaneously with manufacture of the brazed pipe, an inlet member having an inflow passageway communicating with a fluid inlet or an outlet member having an outflow passageway communicating with a fluid outlet is brazed to the brazed-pipe tubular body such that the member extends across the opposite side edge portions of the material plate of the brazed-pipe tubular body, no clearance is formed between the member and the outer surface of the brazed-pipe tubular body. Accordingly, it becomes possible to prevent occurrence of a brazing failure between the headers and the inlet member and the outlet member in the manufactured heat exchanger.

The method of manufacturing a brazed pipe of par. 10) has the following advantage. In the brazed-pipe tubular body formed by forming the material plate into a tubular shape in the step C, the flat surfaces of the opposite side edge portions of the material plate abut against each other, to thereby prevent misalignment between the two slant surfaces, whereby formation of a step on the outer surface of the brazed-pipe tubular body is prevented. Accordingly, the manufactured brazed pipe does not have a step on the outer surface thereof. In addition, since the misalignment between the two slant surfaces can be prevented through formation of the material plate into a tubular shape such that the two flat surfaces abut against each other, no special work for preventing the misalignment is needed, and the manufacturing work becomes simple. Further, since formation of a step on the outer surface of the brazed-pipe tubular body is prevented, the following advantage is attained. For example, in the case where, simultaneously with manufacture of the brazed pipe, an additional component is brazed to the brazed-pipe tubular body such that the component extends across the opposite side edge portions of the material plate of the brazed-pipe tubular body, no clearance is formed between the additional component and the outer surface of the brazed-pipe tubular body. Accordingly, it becomes possible to prevent occurrence of a brazing failure between the manufactured brazed pipe and the additional component.

The methods for manufacturing a brazed pipe of pars. 12) to 15) effectively prevent formation of a step on the outer surface of the brazed-pipe tubular body before undergoing brazing, and formation of a step on the outer surface of the manufactured brazed pipe.

The method of manufacturing a brazed pipe of par. 16) more reliably prevent the misalignment between the two slant surfaces of the brazed-pipe tubular body in a state in which the opposite side edge portions of the material plate have not yet been brazed together.

### BEST MODE FOR CARRYING OUT THE INVENTION

An embodiment of the present invention will next be described with reference to the drawings.

In this embodiment, the present invention is applied to the heat exchanger shown in FIG. 7. In the following description, members which identical with those of FIG. 7 are denoted by the same reference numerals as those used for description of FIG. 7.

FIGS. 1 and 2 show a method of manufacturing a brazed-pipe tubular body used in a header, and FIGS. 3 to 6 show a method of manufacturing a heat exchanger.

First, a material plate (20) formed of a brazing sheet having an aluminum brazing material layer (20a) on each of opposite surfaces thereof is prepared (see FIGS. 1(a) and 2(a)). Subsequently, a right-hand side edge portion of the material plate (20) is pressed from the upper and lower sides thereof by means of, for example, press working, whereby a first slant surface (21) is formed on the upper surface of the material plate (20) such that the first slant surface (21) inclines from the upper surface (first face) side toward the lower surface (second face) side of the material plate (20) while approaching the distal end (right end), and a first flat surface (22) is formed between the lower end of the first slant surface (21) and the lower surface of the material plate (20) such that the first flat surface (22) forms an obtuse angle in relation to the first slant surface (21), and perpendicularly intersects the lower surface of the material plate (20) (see FIG. 1(b)) (step A). Since the first slant surface (21) and the first flat surface (22) are formed on the material plate (20)—which is formed of a brazing sheet having an aluminum brazing material layer (20a) on each of opposite surfaces thereof—through press working that presses the material plate (20) from the upper and lower sides thereof, the first slant surface (21) is covered by the brazing material layer (20a) (see FIG. 2(b)). Notably, the first flat surface (22) is not covered by the brazing material layer (20a). Further, in step A, a portion of the material plate (20) between the upper surface and the first slant surface (21) is caused to bulge upward, whereby an obtuse edge portion (23) is formed between the upper surface of the material plate (20) and the first slant surface (21).

Subsequently, a left-hand side edge portion of the material plate (20) is pressed from the upper and lower sides thereof by means of, for example, press working, whereby a second slant surface (24) is formed on the lower surface of the material plate (20) such that the second slant surface (24) inclines from the lower surface (second face) side toward the upper surface (first face) side of the material plate (20) while approaching the distal end (left end), and a second flat surface (25) is formed between the lower end of the second slant surface (24) and the lower surface of the material plate (20) such that the second flat surface (25) forms an obtuse angle in relation to the second slant surface (24), and perpendicularly intersects the lower surface of the material plate (20) (see FIG. 1(c)) (step B). Since the second slant surface (24) and the second flat surface (25) are formed on the material plate (20)—which is formed of a brazing sheet having an aluminum brazing material layer (20a) on each of opposite surfaces thereof—through press working that presses the material plate (20) from the upper and lower sides thereof, both the second slant surface (24) and the second flat surface (25) are covered by the brazing material layer (20a) (see FIG. 2(c)). In step B, preferably, the width of the second flat surface (25) as measured along the vertical direction is made equal to 20% or more the thickness of the material plate (20). Notably, the width of the second flat surface (25) as measured along the vertical direction is smaller than that of the first flat surface (22). Further, in this step B, an acute edge portion (26) is formed between the upper surface of the material plate (20) and the second slant surface (24). The angle formed at the acute edge portion (26) between the upper surface of the material plate (20) and the second slant surface (24) is the supplementary angle of the angle formed at the obtuse edge portion (23) between the upper surface of the material plate (20) and the first slant surface (21). Further, the brazing material layer (20a) is not present at portions of a left-hand side edge portion of the upper surface of the material plate (20) and a left-hand side edge portion of the second slant surface (24), the portions being located adjacent to the edge portion (26).

Notably, in the present embodiment, the step B is carried out after the step A. However, reversely to that, the step A may be carried out after the step B.

Subsequently, a cutout (27) for forming a fluid inlet (30) (see FIG. 4) and a cutout (28) for forming a partition-member-receiving slit (31) (see FIG. 5) are formed at corresponding positions of the left-hand and right-hand side edge portions of a material plate (20) which is used to form a left-hand header (2) (see FIG. 1(d)). Similarly, a cutout (27) for forming a fluid outlet and a cutout (28) for forming a partition-member-receiving slit (31) are formed at corresponding positions at the left-hand and right-hand side edge portions of another material plate (20) which is used to form a right-hand header (3).

Subsequently, after a curved wall portion (32) which bulges upward and has an arcuate transverse cross section is formed at an intermediate portion of each material plate (20) with respect to the width direction, a plurality of heat-exchange-tube-receiving elongated holes (33) extending in the circumferential direction of the curved wall portion (32) are formed in the curved wall portion (32) at predetermined intervals along the longitudinal direction of the material plate (20) (see FIG. 1(e)). Notably, when the curved wall portion (32) is formed, portions of the material plate (20) located on the left and right sides of the curved wall portion (32) are bent slightly downward such that their upper surfaces are located on the outer side.

Subsequently, each material plate (20) is formed into a tubular shape such that the slant surfaces (21) and (24) of the opposite side edge portions come into surface contact with each other, and the flat surfaces (22) and (25) of the opposite side edge portions abut each other, whereby a brazed-pipe tubular body (34) is obtained (see FIG. 1(f)) (step C). As shown in FIG. 3, since the flat surfaces (22) and (25) of the opposite side edges of the material plate (20), from which the brazed-pipe tubular body (34) is formed, abut each other, misalignment between the slant surfaces (21) and (24) of the brazed-pipe tubular body is prevented, so that no step is formed on the outer surface of the brazed-pipe tubular body (34). Further, the obtuse edge portion (23) is formed between the upper surface of the material plate (20) and the first slant surface (21); the acute edge portion (26) is formed between the upper surface of the material plate (20) and the second slant surface (24); and the angle formed at the obtuse edge portion (23) between the upper surface of the material plate (20) and the first slant surface (21) and the angle formed at the acute edge portion (26) between the upper surface of the material plate (20) and the second slant surface (24) are supplementary angles. These also prevent formation of a step on the outer surface of the brazed-pipe tubular body (34). Moreover, when the material plate (20) is formed into a tubular shape, it is wound around an unillustrated mandrel. Therefore, the inner surface of the brazed-pipe tubular body (34) has no step and is smoothly connected at a location where the flat surfaces (22) and (25) come into contact with each other.

Notably, on the brazed-pipe tubular body (34) of the left-hand header (2), the liquid inlet (30) is formed by the cutout (27), and the partition-member-receiving slit (31) is formed by the cutout (28). On the brazed-pipe tubular body (34) of the right-hand header (3), the liquid outlet is formed by the cutout (27), and the partition-member-receiving slit (31) is formed by the cutout (28).

Further, there are prepared flat heat exchange tubes (4), corrugate fins (5) formed of aluminum, side plates (6) formed of an aluminum brazing sheet having a brazing material layer over each of opposite sides thereof, partition members (7) formed of aluminum, an inlet member (8) formed of aluminum, and an outlet member (9) formed of aluminum.

FIG. 4 shows the heat exchange tubes (4). Each heat exchange tube (4) is fabricated from a metal plate which is formed of an aluminum brazing sheet having a brazing material layer over each of opposite sides thereof and which includes two flat-wall-forming portions, a connection portion which connects the two flat-wall-forming portions and forms one side wall, side wall ridges which project upward from side edges of the two flat-wall-forming portions opposite the connection portion and form the opposite side wall, and a plurality of reinforcement wall ridges integrally formed on the two flat-wall-forming portions. The metal plate is bent at the connection portion into a hairpin-like shape such that the side wall ridges come into engagement with each other and the reinforcement wall ridges come into engagement with each other. In this state, the bent metal plate does not form a complete tube. However, it is denoted by reference numeral (4) as in the case of the heat exchange tubes of the heat exchanger (1) shown in FIG. 1. Notably, the heat exchange tubes (4) may be those formed of an aluminum extrudate having a plurality of parallel fluid channels formed therein.

Subsequently, the two brazed-pipe tubular bodies (34) are disposed such that they are apart from each other; the plurality of heat exchange tubes (4) and the corrugate fins (5) are disposed alternately; opposite end portions of the heat exchange tubes (4) are inserted into the heat-exchange-tube-receiving elongated holes (33) of the brazed-pipe tubular bodies (34) (see FIGS. 4 and 6). Further, the side plates (6) are disposed on the outer sides of the corrugate fins (5) at the opposite ends. Further, closure members (11) formed of aluminum are disposed at the opposite ends of each brazed-pipe tubular body (34). Further, the aluminum partition member (7) is inserted into each partition-member-receiving slit (31) (see FIG. 5); the inlet member (8) is disposed such that its fluid inflow passageway communicates with the fluid inlet (30); and the outlet member (9) is disposed such that its fluid outflow passageway (9a) communicates with the fluid outlet (see FIGS. 4 and 6). All the components are then provisionally fixed by proper means.

After that, the components are heated to a predetermined temperature, whereby the slant surfaces (21) and (24) and the flat surfaces (22) and (25) of each brazed-pipe tubular body (34) are respectively brazed together, whereby brazed pipes (10) are manufactured (step D). Further, the closure members (11) are brazed to the brazed pipes (10) so as to manufacture the headers (2) and (3); and the partition members (7), the inlet member (8), and the outlet member (9) are brazed to the brazed pipes (10). Simultaneously with this, the side wall ridges and reinforcement wall ridges of the heat exchange tubes (4) are respectively brazed together, whereby the heat exchange tubes (4) each assume the form of a complete tube. Further, the heat exchange tubes (4) are brazed to the brazed pipes (10); the heat exchange tubes (4) and the corrugate fins (5) are brazed together; and the corrugate fins (5) and the side plates (6) are brazed together. Thus, the heat exchanger (1) is manufactured.

The heat exchanger (1) is used as a condenser of a refrigeration cycle which includes a compressor, the condenser, a pressure reducer, and an evaporator and which uses a chlorofluorocarbon-based refrigerant. The refrigeration cycle is installed in a vehicle as a car air conditioner.

In each of the brazed pipes (10), which constitute the two headers (2) and (3) of the heat exchanger (1), of the opposite side edge portions of the material plate overlapped with each other, a first side edge portion located on the inner side has a first slant surface which is formed on the outer surface thereof such that the first slant surface inclines inward toward the distal end; and a second side edge portion located on the outer side has a second slant surface which is formed on the inner surface thereof such that the second slant surface inclines outward toward the distal end. A first flat surface is formed between the first slant surface and the inner surface of the first side edge portion such that the first flat surface forms an obtuse angle in relation to the first slant surface, and a second flat surface is formed between the second slant surface and the inner surface of the second side edge portion such that the second flat surface forms an obtuse angle in relation to the second slant surface and the first flat surface abuts against the second flat surface. The opposite side edge portions of the material plate are brazed together in a state where the two slant surfaces are in surface contact with each other and the two flat surfaces are in surface contact with each other. Further, an obtuse edge portion is formed between the outer surface and the first slant surface of the first side edge portion, and an acute edge portion is formed between the outer surface and the second slant surface of the second side edge portion, so that the outer surfaces of the opposite side edge portions are smoothly connected. Further, the width of the second flat surface of the second side edge portion as measured along the thickness direction of the material plate is equal to or greater than 20% the thickness of the material plate; and the inner edge of the first flat surface of the first side edge portion projects inward from the inner edge of the second flat surface of the second side edge portion.

In the above-described embodiment, the two headers of the heat exchanger are divided by respective partition members into equal numbers of header sections; a fluid inlet is formed in one longitudinal end portion of a first header; and a fluid outlet is formed in the opposite longitudinal end portion of a second header. However, the configuration of the headers is not limited thereto, and may be configured such that a first header of the heat exchanger is divided by a partition member(s) into a plurality of header sections; a second header has header sections which number one less than the header sections of the first header and each of which faces adjacent two header sections of the first header; a fluid inlet is formed in the header section located at one end of the first header with respect to the longitudinal direction; and a fluid outlet is formed in the header section located at the other end of the first header with respect to the longitudinal direction.

### INDUSTRIAL APPLICABILITY

The method of manufacturing a brazed pipe according to the present invention is suitable for manufacture of headers of a heat exchanger, such as a condenser or an evaporator for car air conditioners, or an oil cooler for automobiles.

### BRIEF DESCRIPTION OF THE DRAWINGS

FIG. 1 is a set of vertical cross sectional views showing, in the order of steps, a method of manufacturing brazed-pipe tubular bodies used in headers of a heat exchanger.

FIG. 2 is a set of partial enlarged views of FIG. 1.

FIG. 3 is a cross sectional view showing, on an enlarged scale, a portion of a brazed-pipe tubular body.

FIG. 4 is a partial exploded perspective view showing a method of combining the brazed-pipe tubular body, heat exchange tubes, and an inlet member.

FIG. 5 is a partial exploded perspective view showing a method of combining the brazed-pipe tubular body and a partition member.

FIG. 6 is a sectional view showing a state in which an inlet member or an outlet member is combined with the brazed-pipe tubular body.

FIG. 7 is a perspective view showing the overall structure of a heat exchanger used as a condenser of a car air conditioner.

FIG. 8 is a sectional view showing, on an enlarged scale, a portion of a brazed-pipe tubular body used in the headers of a conventional heat exchanger.

FIG. 9 is a sectional view showing a state in which an inlet member or an outlet member is combined with the brazed-pipe tubular body of FIG. 8.

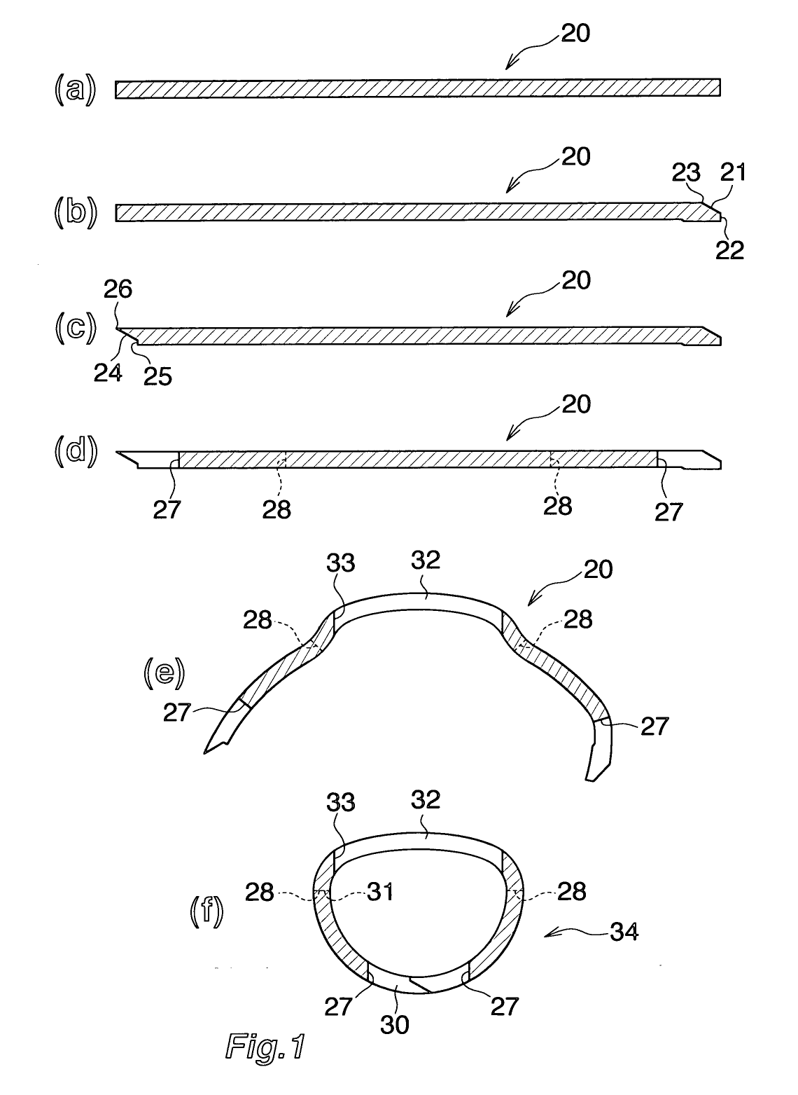

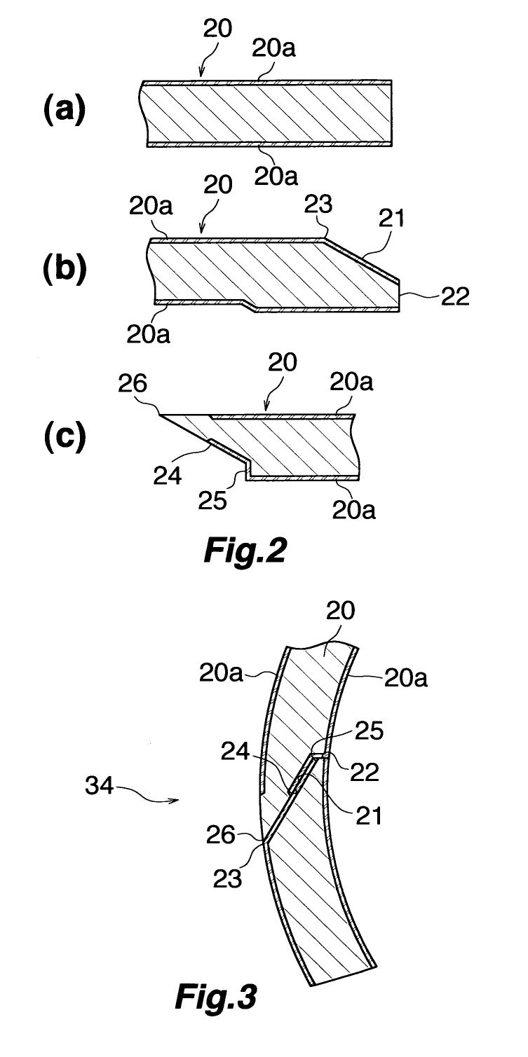

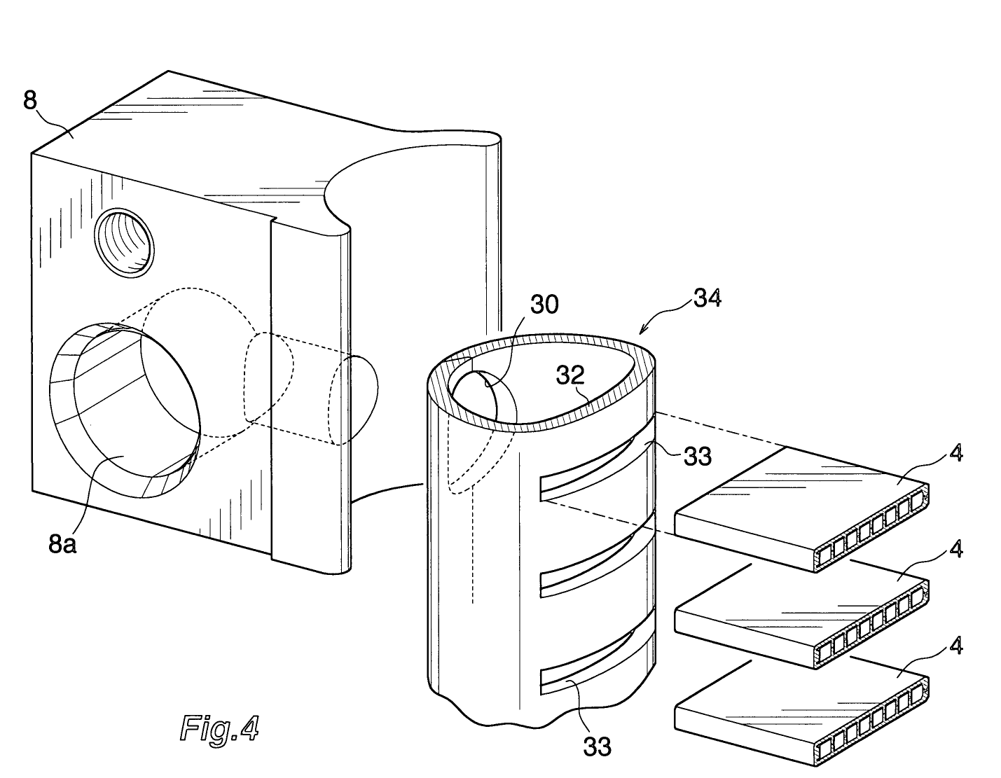

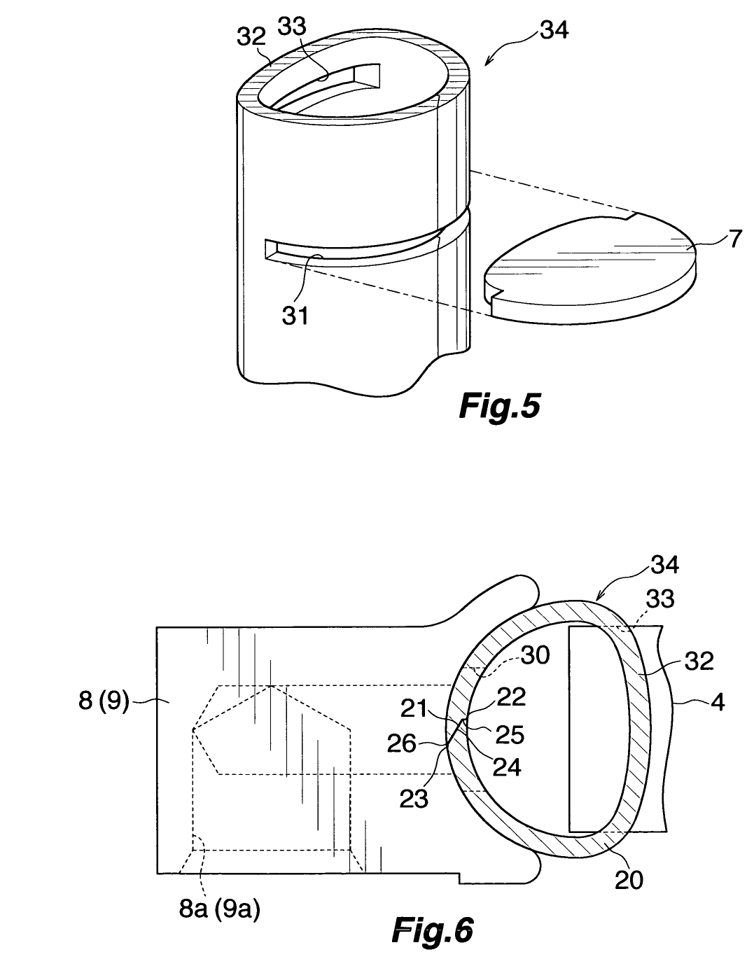

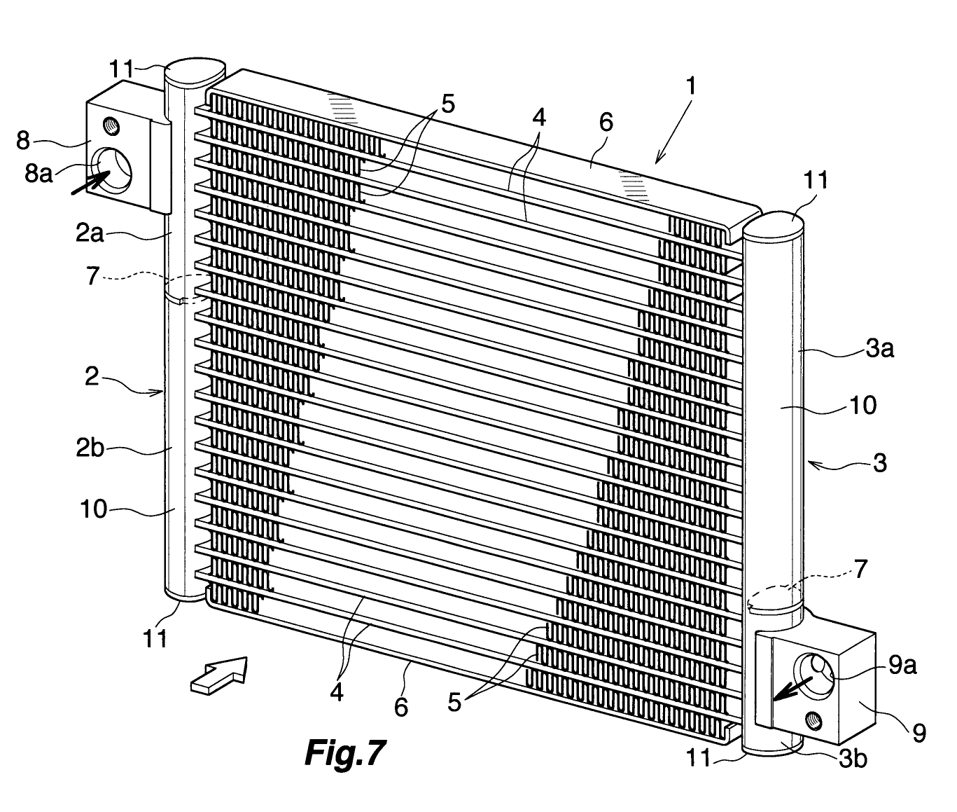

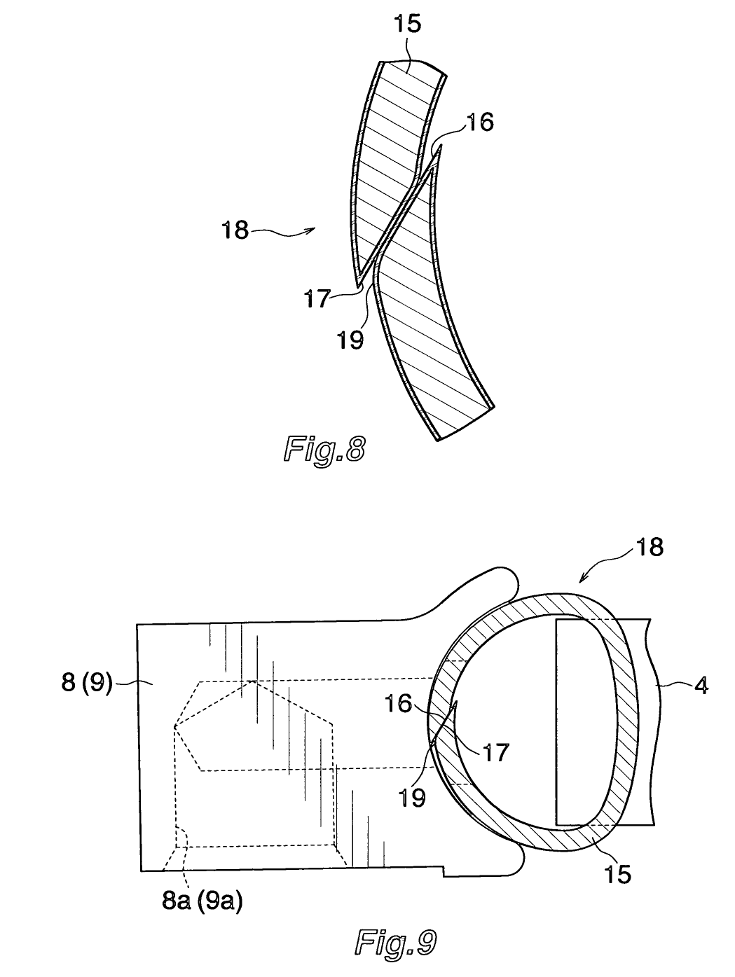

1: A brazed pipe fabricated through a process in which a material plate formed of a brazing sheet having a brazing material layer over each of opposite surfaces thereof is formed into a tubular shape, and opposite side edge portions of the material plate are partially overlapped with each other and brazed together by making use of the brazing material layer of the material palate, wherein
of the opposite side edge portions of the material plate overlapped with each other, a first side edge portion located on the inner side has a first slant surface which is formed on the outer surface thereof such that the first slant surface inclines inward toward a distal end of the first side edge portion; a second side edge portion located on the outer side has a second slant surface which is formed on the inner surface thereof such that the second slant surface inclines outward toward a distal end of the second side edge portion; a first flat surface is formed between the first slant surface and the inner surface of the first side edge portion such that the first flat surface forms an obtuse angle in relation to the first slant surface; a second flat surface is formed between the second slant surface and the inner surface of the second side edge portion such that the second flat surface forms an obtuse angle in relation to the second slant surface and the first flat surface abuts against the second flat surface; and the opposite side edge portions of the material plate are brazed together in a state where the first and second slant surfaces are in surface contact with each other and the first and second flat surfaces are in surface contact with each other.

2: A brazed pipe according to claim 1, wherein an obtuse edge portion is formed between the outer surface and the first slant surface of the first side edge portion; and an acute edge portion is formed between the outer surface and the second slant surface of the second side edge portion, so that the outer surfaces of the opposite side edge portions are smoothly connected.

3: A brazed pipe according to claim 1, wherein the width of the second flat surface of the second side edge portion as measured along the thickness direction of the material plate is equal to or greater than 20% the thickness of the material plate.

4: A brazed pipe according to claim 1, wherein an inner edge of the first flat surface of the first side edge portion projects inward in relation to an inner edge of the second flat surface of the second side edge portion.

5: A header for a heat exchanger which is formed by closing opposite end openings of the brazed pipe according to claim 1 by closure members, wherein a curved wall portion which bulges outward and has an arcuate transverse cross section is formed at a portion of the material plate excluding the overlapping opposite side edge portions thereof; and a plurality of heat-exchange-tube-receiving elongated holes extending in a circumferential direction of the curved wall portion are formed in the curved wall portion at predetermined intervals along a longitudinal direction thereof.

6: A heat exchanger comprising a pair of headers spaced apart from each other, a plurality of heat exchange tubes disposed between the headers and having opposite end portions connected to the corresponding headers, and fins disposed between adjacent heat exchange tubes, wherein
each of the headers is formed of the header for a heat exchanger according to claim 5; and the opposite end portions of the heat exchange tubes are inserted into the heat-exchange-tube-receiving elongated holes of the headers and are brazed to the corresponding brazed pipes.

7: A heat exchanger according to claim 6, wherein at least one header is divided by a partition member into a plurality of header sections arranged in a longitudinal direction of the header; and the partition member is inserted into the brazed pipe through a partition-member-receiving slit and brazed to the brazed pipe, the partition-member-receiving slit being formed across the opposite side edge portions of the material plate of the brazed pipe, which constitutes the header.

8: A heat exchanger according to claim 6, wherein the two headers are divided by respective partition members into equal numbers of header sections; a fluid inlet is formed in an one longitudinal end portion of a first header; a fluid outlet is formed in the opposite longitudinal end portion of a second header; and the fluid inlet and the fluid outlet are formed across the opposite side edge portions of the corresponding material plates of the respective brazed pipes, which constitute the first and second headers.

9: A heat exchanger according to claim 6, wherein a first header is divided by a partition member(s) into a plurality of header sections; a second header has header sections which number one less than the header sections of the first header and each of which faces adjacent two header sections of the first header; a fluid inlet is formed in a header section located at one longitudinal end of the first header; a fluid outlet is formed in a header section located at the other longitudinal end of the first header; and the fluid inlet and the fluid outlet are formed across the opposite side edge portions of the material plate of the brazed pipe which constitutes the first header.

10. A method of manufacturing a brazed pipe, comprising:
a step A of forming, on one side edge portion of a material plate formed of a brazing sheet having a brazing material layer over each of opposite surfaces thereof, a first slant surface such that the first slant surface is located on a first face of the material plate and inclines from the first face toward a second face of the material plate while approaching a distal end of the one side edge portion, and forming a first flat surface between the first slant surface and the second face such that the first flat surface forms an obtuse angle in relation to the first slant surface;
a step B of forming, on the other side edge portion of the material plate, a second slant surface such that the second slant surface is located on the second face of the material plate and inclines from the second face toward the first face of the material plate while approaching a distal end of the other side edge portion, and forming a second flat surface between the second slant surface and the second face such that the second flat surface forms an obtuse angle in relation to the second slant surface;
a step C of forming the material plate into a tubular shape such that the first face thereof is located on the outer side such that the first and second slant surfaces of the opposite side edge portions are in surface contact with each other and the first and second flat surfaces of the opposite side edge portions abut against each other, to thereby obtain a brazed-pipe tubular body; and
a step D of brazing together the first and second slant surfaces and the first and second flat surfaces, respectively, of the opposite side edge portions of the material plate, which forms the brazed-pipe tubular body, by making use of the brazing material layer of the material plate,
wherein, after one of the steps A and B is performed, the remaining one of the steps A and B is performed, and then the steps C and D are performed in this sequence.

11. A method of manufacturing a brazed pipe according to claim 10, wherein the first slant surface of the material plate formed in the step A and the second slant surface and the second flat surface of the material plate formed in the step B are each covered by the brazing material layer.

12: A method of manufacturing a brazed pipe according to claim 10, wherein, in the step A, a portion of the material plate between the first face and the first slant surface is partially bulged toward the first face side to thereby form an obtuse edge portion between the first face and the first slant surface of the material plate.

13: A method of manufacturing a brazed pipe according to claim 10, wherein, in the step A, the first flat surface is formed such that the first flat surface perpendicularly intersects the second face of the material plate.

14: A method of manufacturing a brazed pipe according to claim 10, wherein, in the step B, an acute edge portion is formed between the first face and the second slant surface of the material plate.

15: A method of manufacturing a brazed pipe according to claim 10, wherein, in the step B, the second flat surface is formed such that the second flat surface perpendicularly intersects the second face of the material plate.

16: A method of manufacturing a brazed pipe according to claim 10, wherein, in the step B, the second flat surface is formed such that the width of the second flat surface becomes equal to or greater than 20% the thickness of the material plate.

17: A method of manufacturing a brazed pipe according to claim 10, wherein, in the step B, the second flat surface is formed such that the width of the second flat surface becomes smaller than that of the first flat surface formed in the step A.

18: A method of manufacturing a brazed pipe according to claim 10, wherein the brazed-pipe tubular body obtained in the step C has a step-free, smoothly connected inner surface at a location where the first and second flat surfaces are in contact with each other.

19: A method of manufacturing a header for a heat exchanger, wherein in the step C of the method of manufacturing a brazed pipe according to claim 10, before the material plate is formed into a tubular shape, a curved wall portion which bulges toward the first face side and has an arcuate transverse cross section is formed at an intermediate portion of the material plate with respect to a width direction thereof, and a plurality of heat-exchange-tube-receiving elongated holes extending in a circumferential direction of the curved wall portion are formed in the curved wall portion at predetermined intervals along a longitudinal direction of the material plate; and after completion of the step C, closure members are disposed at opposite end portions of the brazed-pipe tubular body formed from the material plate, and are brazed to the brazed-pipe tubular body, simultaneously with the mutual brazing of the first and second slant surfaces and the mutual brazing of the first and second flat surfaces in the step D.

20: A method of manufacturing a heat exchanger comprising a pair of headers spaced apart from each other, a plurality of heat exchange tubes disposed between the headers and having opposite end portions connected to the corresponding headers, and fins disposed between adjacent heat exchange tubes, wherein, after completion of the step C of the method according to claim 19, two brazed-pipe tubular bodies each formed of the material plate are disposed such that they are spaced apart from each other; the opposite end portions of the heat exchange tubes are inserted into the heat-exchange-tube-receiving elongated holes of the corresponding brazed-pipe tubular bodies; the fins are disposed between adjacent heat exchange tubes; and the heat exchange tubes are brazed to the brazed-pipe tubular bodies and the fins are brazed to the heat exchange tubes, simultaneously with the mutual brazing of the first and second slant surfaces, the mutual brazing of the first and second flat surfaces, and the brazing of the closure members to the brazed-pipe tubular bodies in the step D.

21: A method of manufacturing a heat exchanger according to claim 20, wherein, after completion of the steps A and B, cutouts are formed at corresponding positions of the opposite side edge portions of the material plate, from which at least one brazed-pipe tubular body is formed, whereby a partition-member-receiving slit is formed across the opposite side edge portions of the brazed-pipe tubular body obtained in the step C; a partition member is inserted into the brazed-pipe tubular body through the slit before performance of the step D; and the partition member is brazed to the brazed-pipe tubular body simultaneously with the brazing of the relevant components in the step D.
